(19) United States
(12) Patent Application Publication
(10) Pub. No.: US 2009/0064321 A1
(43) Pub. Date: Mar. 5, 2009

(54) Methods for Providing User Authentication in a Computer Network or System

(76) Inventors: Richard S. Dick, Alpine, UT (US); Mary Patricia Wagner, Alpine, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/846,691

(22) Filed: Aug. 29, 2007

(51) Int. Cl. H04L 9/32

(52) U.S. Cl. 726/21

(57) ABSTRACT

Embodiments of the present invention relate to methods for providing user authentication for a computer-type device or for a computer network. The method includes showing an interactive display comprising a plurality of media items. The plurality of media items may include a pre-designated authentication media item. A user is prompted to select the pre-designated media item from the plurality of media items, and may further be prompted to select a pre-designated location in the pre-designated media item. Network or other authentication may be provided if the user selects the pre-designated media item (and location) from the plurality of media.

### BACKGROUND OF THE INVENTION

1. Field of the Invention

Embodiments of the present invention relate to electronic communications. In particular, systems and methods for authenticating the identity of electronic systems users, including network users, computer users, and the like are disclosed.

2. Background and Related Art

A variety of computer networks are used today. These networks include the Internet, intranets, local area networks (LANs), metropolitan area networks (MANs), wide area networks (WANs), and other types of networks. Networks are used for various purposes, including to access and provide data, communicate, and transact business. For many of these purposes it is frequently necessary to authenticate a network user's identity. It is also frequently desirable to authenticate the identity of a user of a computer device, such as a laptop, desktop, workstation, personal digital assistant (PDA), smart phone, or other computer device.

One known authentication scheme requires a user to have a username and password. Passwords provide some level of security, but are not fail-safe. One reason that passwords sometimes fail to provide adequate security is because people write them down, use predictable words and names as password, and/or repeatedly use the same password for multiple applications and/or situations. Moreover, computer hackers can obtain and/or guess passwords using password generators or keyboard/keystroke monitors. Finally, some users may forget their password information, leading to difficulty in later failed authentication attempts by authorized users.

Other authentication schemes replace or are combined with username and password authentication. Some schemes require a user to provide information about themselves or their identity. These schemes ask the user one or more challenge questions that they must answer correctly to gain access to particular network data. Often this information is basic in nature and sometimes referred to as wallet-type information. One reason that these schemes fail is that wallet-type information may be found in stolen wallets and purses, in discarded trash, or may be available as common knowledge to associates, friends, and acquaintances. Such information may also be available through public records or may otherwise be easily obtainable.

Thus, while techniques currently exist that provide network authentication schemes, challenges still exist, including providing more secure authentication schemes. Accordingly, it would be an improvement in the art to augment or even replace current techniques with other techniques.

### BRIEF SUMMARY OF THE INVENTION

Embodiments of the present invention relate to electronic communications. In particular, systems and methods for authenticating the identity of electronic systems users, including network users, computer users, and the like are disclosed.

Implementation of the present invention takes place in computers, electronic devices, computer network environments, and the like and provides a method for authenticating a user's identity using an interactive display, such as a webpage, pop-up authentication screen, etc. The interactive display prompts a user to select a pre-designated authentication media from a group of media items included on the interactive display. Media items may include, for example, images, video, and audio media. In some embodiments, the user may be further prompted to select a pre-designated location in the selected media item. The location may be spatial, temporal, or both spatial and temporal, depending on the type of media selected. In some embodiments, the selection of a location may occur in a zoom-in fashion, essentially providing additional layers of authentication security.

Prior to accessing the interactive display a user may pre-designate one or more media item(s) and may further designate a location in the media item. The media item(s) and/or selections are then provided to the network, computer, or electronic device, etc. for use with the interactive display and authentication procedure(s). When the interactive display is presented, the user selects one of the media items from the group of media items, and may further select a location in/on the media item. If the user selects the pre-designated media item, and location if designated, network or other authorization may be provided. In some embodiments, a designator may be provided indicating that none of the displayed media items is one of the pre-designated media items, and selection of the designator provides additional media items for selection, one of which may be one of the pre-designated media items. This may provide additional authentication security.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE SEVERAL VIEWS OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative computer environment for use with embodiments of the invention;

FIG. 2 illustrates a representative network computer environment for use with embodiments of the invention;

FIG. 3 shows an interactive display according to embodiments of the invention;

FIG. 4 shows an alternative interactive display;

FIG. 5 shows an alternative interactive display;

FIG. 6 shows an alternative interactive display; and

FIG. 7 illustrates a flow chart for authentication in accordance with embodiments of the disclosed methods.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the present invention relate to electronic communications. In particular, systems and methods for authenticating the identity of electronic systems users, including network users, computer users, and the like are disclosed.

Embodiments of the present invention embrace an authentication method that may be employed with all types of computers, computer devices, computer-like devices, electronic devices, computer networks and network applications. Non-limiting examples of such devices include personal desktop, laptop, and notebook computers, computer workstations, personal digital assistants (PDAs), smart phones, security access panels, and the like. Non-limiting examples of networks include: the Internet, intranets, local area networks (LANs), metropolitan area networks (MANs), wide area networks (WANs), and other like computer networks. Embodiments of the present invention may be employed in a variety of network applications. For example, networks applications may include, but are not limited to on-line accounts (i.e. bank accounts, e-mail accounts, etc.), members-only websites, on-line services (i.e. credit report services, insurance quote services, etc.), network document servers or managers, network software applications, protected documents, and the like. In a particular example, an Internet banking website may utilize the authentication methods described herein to authenticate a user's identity when the user attempts to access on-line banking services.

Embodiments of the invention operate in computer environments and provide methods for authenticating a user's identity using an interactive display that prompts a user to select a pre-designated authentication media item from a plurality of media items included on the interactive display. In some embodiments, none of the plurality of media items included on the interactive display is a pre-designated media item, and selection of a pre-designated media item requires requesting display of additional media items. Embodiments of the present invention embrace all types of media, wherein media refers to images, video, sound, and other audio/visual media forms. Non-limiting examples of images that may be employed in the interactive display include: photographs, icons, shapes, solid colors, patterns hand sketches, one or more shapes, calendars, and the like. Non-limiting examples of video that may be employed in the interactive display include: video clips, slide presentations, entire videos and the like. Non-limiting examples of audio media that may be employed in the interactive display include: music, recorded speech, sound bites and the like.

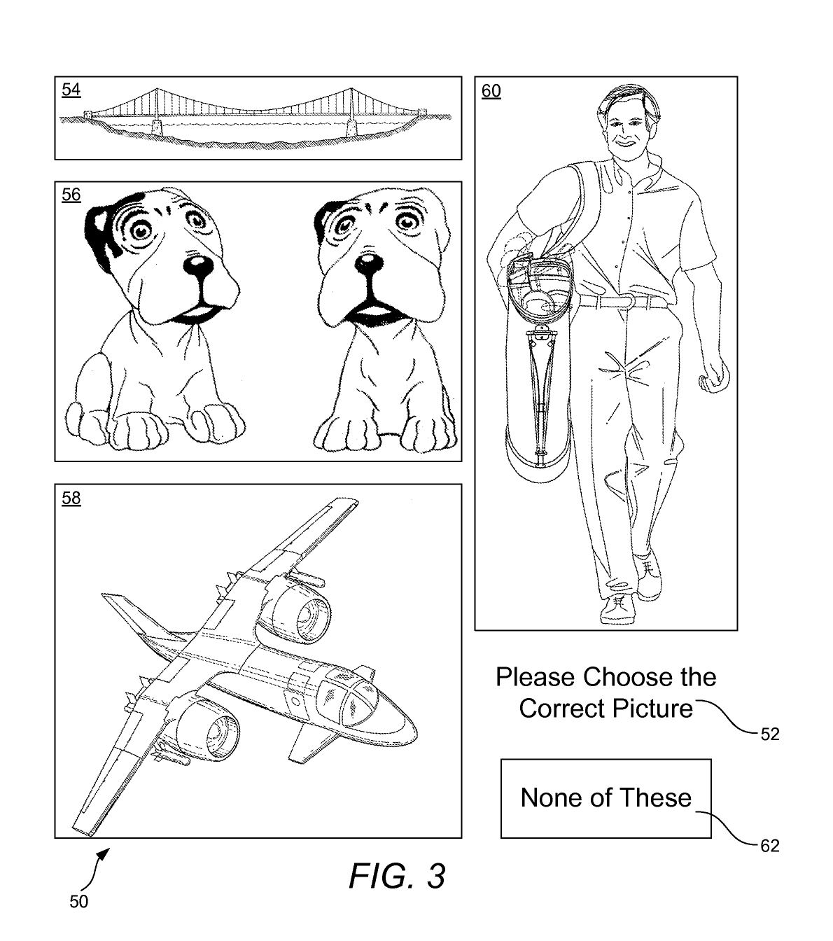

According to embodiments of the invention, a user may pre-designate one or more media items to be a pre-designated media item that may be included in an interactive display, such as an interactive display 50 shown in FIG. 3. The pre-designated media may act similarly to a visual or audible password, where the user designates one or more media items that will be included as one of several media item options in an authentication query (such as that depicted in the interactive display 50 of FIG. 3). The authentication query, which may be part of the interactive display 50, may show or otherwise access a group of media items and may prompt the user to select the media item that the user pre-designated from the group shown. The interactive display accesses and/or generates one or more non-designated media items that may be included with the pre-designated media item in the group of media items. Network or other similar authorization may be granted if the user selects the pre-designated media item from the group of media items. If the user selects a non-designated media item (an incorrect item) from the group, network authorization is not granted.

Several advantages exist when a user pre-designates a media item for use in a media-based authentication scheme. First, by their nature, media items, such as pictures, designs, music, video clips, and the like, are typically easier to remember than passwords. For example, a user may pre-designate a photograph as their pre-designated media item. Users will naturally recognize one or more pre-designated photographs, favorite photographs, photographs of a memorable events, items, or locations. Likewise, favorite and/or memorable songs or movie clips will be easily recognized by valid users, but may not necessarily be obvious to non-valid users, to whom each of the pre-designated media items will merely be one among many media items.

Additionally, media items provide a higher level of security than personal information because they are not available to wallet thieves, printed on paper that is thrown in the trash, or available in one's personal files. For example, a user may select the color red as their media item, which may be later included on an interactive display displaying a group of media items consisting of ten colors, such as solid-colored square blocks. Because the color red may be a personal preference or otherwise memorable, or simply because the user easily remembers that the color red was the color selected, it will not need to be written down and therefore will not be included in any documentation that may be stolen or found. Thus, using pre-designated media items for authentication purposes provides a highly secure authentication scheme.

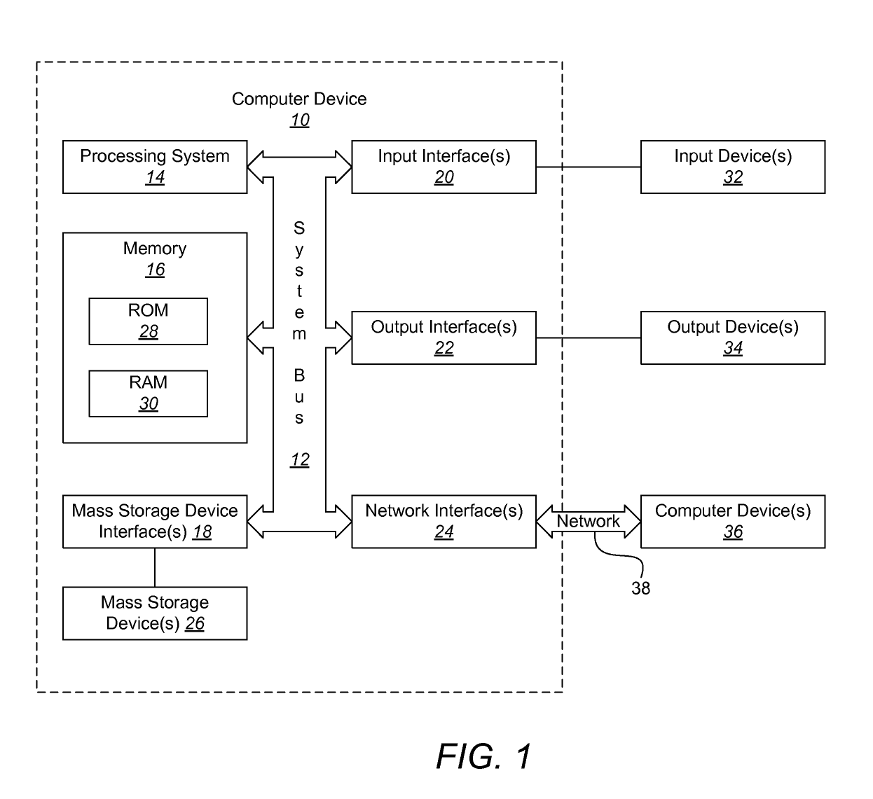

FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing embodiments of the invention includes computer device 10, which may be a general-purpose or special-purpose computer. For example, computer device 10 may be a personal computer, a notebook or laptop computer, a PDA or other hand-held device, a workstation, a minicomputer, a mainframe, a supercomputer, a multi-processor system, a network computer, a processor-based consumer electronic device, a smart phone, a security access panel, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

Those skilled in the art will appreciate that embodiments of the present invention embrace a variety of different system configurations. For example, in one embodiment the system configuration includes an output device (e.g., a multifunctional peripheral (MFP) or other printer/plotter, a copy machine, a facsimile machine, a monitor, etc.) that performs multi-colorant rendering. In another embodiment, the system configuration includes one or more client computer devices, optionally one or more server computer devices, and a connection or network communication that enables the exchange of communication to an output device, which is configured to perform multi-colorant rendering.

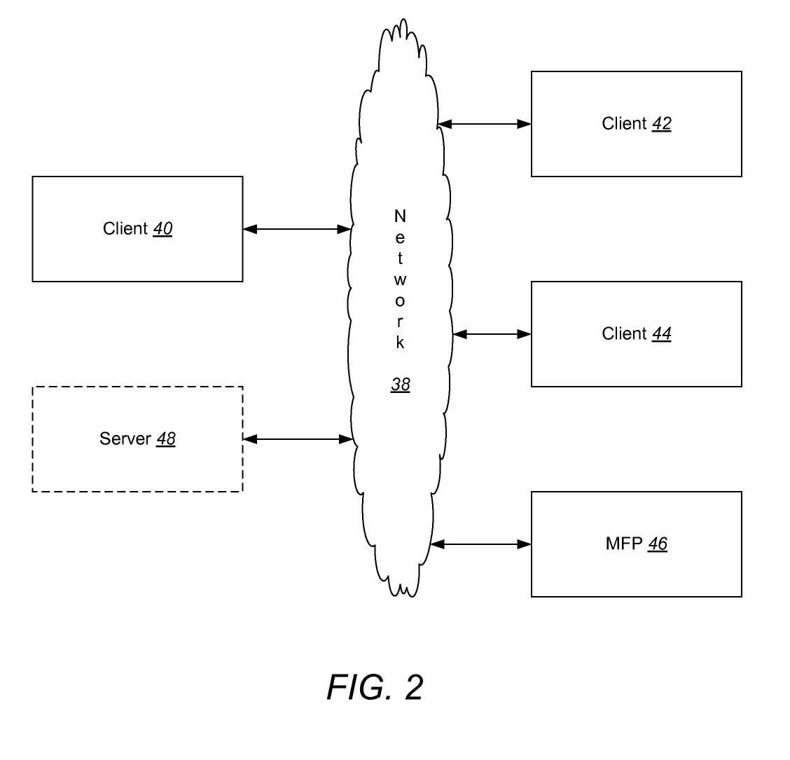

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

FIG. 3 and the corresponding discussion are intended to provide an exemplary description of an interactive display such as interactive display 50 according to embodiments of the present invention. One skilled in the art will appreciate that the invention may be practiced using a variety of interactive display screens and network applications. For example, non-limiting examples of an interactive display such as interactive display 50 include a webpage, a pop-up, an authentication page to access a computer device and the like. In some embodiments, the interactive display may be generated in response to a command from a network application to authenticate the identity of a network user. As will be further discussed below, the interactive display may be a second authentication step or second factor authentication and thus may generated in response to a command from a network application or from any device access after a first level authentication step is completed.

The interactive display 50 shown in FIG. 3 is depicted without including additional features that may be shown based on the application used in conjunction with the interactive display 50. For example, as will be appreciated by one of skill in the art, the interactive display 50 may be used in conjunction with a web-based authentication scheme, and in such embodiments, the interactive display 50 might be displayed within a window of a web browser. Therefore, additional elements not specifically described in relation to FIG. 3 may be utilized in conjunction with the interactive display 50.

As shown in the illustrative embodiment depicted in FIG. 3, the interactive display 50 may includes a prompt 52 for the user to select a pre-designated image. Alternatively, the prompt 52 for the user to select the pre-designated image may be displayed to the user prior to providing the media for selection in the interactive display 50. Four images 54, 56, 58, and 60 are included in the interactive display 50 shown in FIG. 3, the images being a form of media. In other embodiments, the number of media items images can be less than or greater than four, for example, within a range of two to fifty. Selecting media may be performed by highlighting the media item with a mouse click and then select a “submit” button (not shown). Other non-limiting examples of selecting a media item include: clicking on a media icon with a mouse, double click on the media with a mouse, typing the number or name of a media item into a text box, or the like. Any mechanism for selecting a media item is embraced by the embodiments of the invention.

Several schemes may be utilized to generate the interactive display 50 and select a group of media items for inclusion in the interactive display 50. In one embodiment, the interactive display may be generated with media of only one type, for example all sound media, all video clips, all color patches or patterns, or all images. In another embodiment, the interactive display may be generated with a variety of media types, for example, a selection of images, video media, and audio media that form the group of media items. In another embodiment, the interactive display 50 may generate or select non-designated media items of a same genre or class as the pre-designated media item(s). For example, if a music clip of classical music is the pre-designated media other classical music clips can be included as non-designated media. Accordingly, if a user selects and/or submits a media item they can also submit information describing the genre, class, and/or type of media item they are submitting/selecting. Alternatively and additionally, if a music clip of classical music is designated as the pre-designated media, non-classical music may be included in the group of media. Inclusion of media similar to the pre-designated media may prevent an unauthorized individual from using knowledge of the authorized individual to make an educated guess of the pre-designated media item.

While FIG. 3 includes media items in the form of images, it will be understood that a variety of media types may be included, as described above. For audio and/or video media an icon can be included on an interactive display to represent the media. Users may access or preview these media items by clicking on the media, dragging a mouse pointer to hover over the media, and the like. In addition to using an icon to represent audio and video media other forms may be presented on the interactive display, including, for example: text of the song/movie title, text of music lyrics, name of a movie scene, phrases from a movie scene, images of a CD/DVD album from which the media was taken, text of artist/actor name, pictures of the artist, and the like. Additionally, blank or labeled boxes may be included whereon a user may click or pass a mouse pointer over to preview the audio or video media item.

Access to a network application or site may be granted if a user selects the pre-designated media from the group of media items on the interactive display. However, access may be denied a user if the user selects an incorrect media item from the interactive display one or more times. The interactive display may implement various schemes when an incorrect media item is selected. According to one embodiment, a user may be presented with an alternate interactive display, wherein the pre-designated media item is a different pre-designated media item. According to this and other embodiments, a user may pre-designate two or more media items. A pre-defined number of attempts may be provided to a user, wherein in each attempt to select the pre-designated media the user is presented with an interactive display having a different pre-designated media item. This pre-defined number of attempts may be, for example between one and five. If a user fails to select the pre-designated media in the pre-defined number of attempts he may be denied access into the network application or site. This denied access may be permanent or temporary for the given computer or user, such as based on the computer's media access control (MAC) address or based on the IP address from which access is sought, for example.

According to other embodiments of the invention, a user may be required to re-designate new media items after one or more failed attempts is made to correctly select the pre-designated media items from an interactive display. In one exemplary embodiment, the network or website manager may notify a user of failed authentication attempts and then instruct the user to re-designate new media items. In some embodiments, re-designating new media items may require a user to authenticate their identity by providing personal information, or other by using another authentication scheme, as is known to those of skill in the art.

To pre-designate one or more media items, a user may, for example: select one or more media item from a plurality of media items on a network site; upload one or more media items to a network site; mail a hard copy of an image or picture; mail or e-mail a digital copy of a media item such as a video or audio media; and other such ways that may be appreciated by those of skill in the art.

In the embodiment illustrated in FIG. 3, additional protection to ensure proper authentication of the user may be provided by the inclusion of a “none” designator 62. The “none” designator 62 reduces the possibility that a non-authorized user who reaches the point of media authentication of the user's identity will be able to bypass the media authentication procedure. For example, if a “none” designator 62 is not included, the unauthorized user might log into the network (or other) system and get to the point of selecting the proper media item. The unauthorized user could then record the media items displayed and then exit the system. By repeatedly performing these steps of accessing, recording media items displayed, and then exiting, the unauthorized user could potentially discover which media item is the pre-designated media by determining which media item is consistently presented as an option.

The “none” designator 62 reduces the potential for success for the unauthorized user by allowing the presentation of multiple panels or screens of media items, accessible in series using the “none” designator 62. For example, by presenting up to four panels of images with between four and six pictures each in conjunction with the “none” designator 62, the unauthorized user's access problem is greatly complicated. Further, when used in conjunction with multiple pre-designated media items and the potential repetitious inclusion of non-designated media items, the unauthorized user is unable to use login and quick exit procedures to discover the pre-designated media item(s).

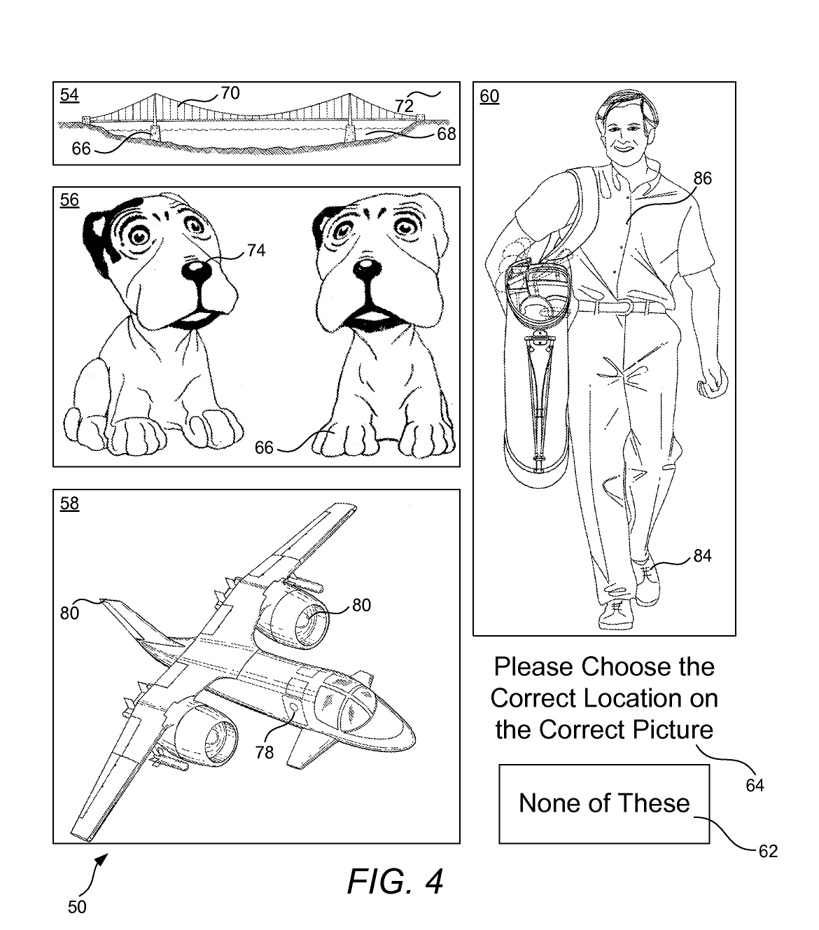

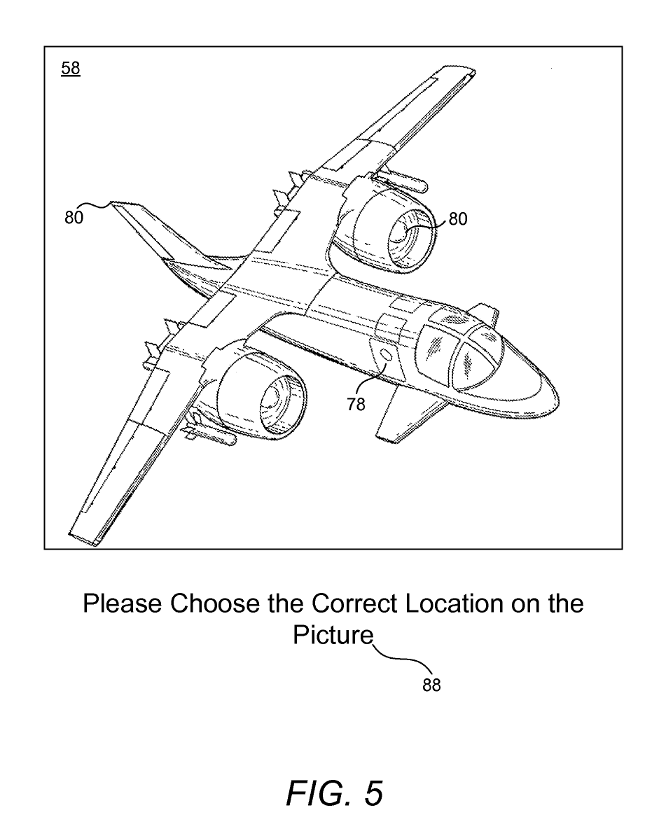

In some embodiments of the invention, additional security may be provided by requiring further input from the user as will be illustrated in conjunction with FIGS. 4 and 5. For example, an alternate interactive display 50 is illustrated in FIG. 4. In the interactive display 50 of FIG. 4, the prompt 52 to select the correct image has been replaced with a prompt 64 to select the correct location on the correct image. As may be appreciated by one of skill in the art, this greatly complicates the problem for a would-be unauthorized user with very little or no additional difficulty for an authorized user. For the authorized user, the only additional step required during the pre-designation of media is the selection/pre-designation of a location on/in the selected media. Such selection/pre-designation of a location on/in the selected media may be spatial, such as for visual media, or it may be temporal, such as for audio or video media. In some embodiments, the designation of a location may be both spatial and temporal, such as for video media.

For example, for embodiments using audio media, a media clip may begin playing at the beginning of the media clip when the user hovers or positions the mouse pointer over an icon representing the media clip. The user may then designate a temporal location in the media by clicking on the icon at the proper time, such as at the second beat of the fourth bar of a music recording, at the second crash of the cymbals, or when a particular word is spoken during an audio recording. This is an example of a temporal location designation. As may be appreciated by one of skill in the art, the user authentication process may be programmed to recognize and accept a designated degree of error in the temporal selection upon user authentication. For example, during authentication, the user may click up to one-half, one-quarter, or one-tenth of a second before or after the pre-designated temporal location, and such action by the user may be accepted as authentication of the user. One of skill in the art will be able to determine other intervals of temporally-acceptable margins of error through the practice of these embodiments of the invention. For example, it may be appreciated that for high-security situations, temporal authentication may be required in a more narrow temporal window, say of one-tenth second overall, while for lower-security situations, a temporal window of one second may be sufficient to provide the necessary security.

As an example of a spatial-temporal selection of a location for authentication, such as for a video clip, suppose the user pre-designated a clip from the movie “Ghostbusters” as the user's pre-designated media. The user might select/designate the right eye of the Stay-Puft Marshmallow Man the first time it becomes visible as the user's selected spatial-temporal location. Then during authentication, the authorized user could begin playback of the video clip (either by positioning the pointer over the media item/icon representing the media item or by selecting “play” or by some other means known in the art), and could then click on the right eye of the Stay-Puft Marshmallow Man when it became visible during playback. As may be appreciated by one of skill in the art, some leniency in both temporal selection and spatial selection may be permitted and recognized as correct user authentication, as is discussed above regarding temporal selection and below regarding spatial selection. As will be readily appreciated, improper authentication of an unauthorized user is extraordinarily difficult to achieve using such systems.

FIG. 4 illustrates a spatial-only location selection system, such as may be used with images, color blocks, pattern blocks, and/or photographs. If the user selects the image 54 of the suspension bridge as his or her pre-designated media, the user may select any portion of the image 54 as his or her pre-designated location. By way of example, the user may select the left pylon 66 as the user's location. Alternatively, the user could select the water 68 to the right of the right pylon as the user's pre-designated location. A different user might use the same image, but might designate the third cable to the right 70 of the left pylon as that user's selected location, or might choose a location in the sky 72 near the upper right corner as the selected location.

If the user's image is the image 56, the user might designate the left dog's nose 74, or the right dog's right paw 76 as the user's pre-designated location. If the user selected the image 58 of the plane, the user might choose the door 78 of the plane, the tip 80 of the tail fin, or the intake 82 of the left engine as the pre-designated location. If the user's image is the image 60, the user might select the golfer's left shoe 84, or the second button down 86 on the golfer's shirt. Each of the above-listed locations is illustrative only, and one of skill in the art will recognize that the user may select any location on the user's pre-designated image(s) that the user will be able to remember and reliably re-select in the future. For example, a user might even select a location outside of the user's chosen media item or image; one user might choose to select a location a defined distance and height to the upper left of the user's selected media item. In other embodiments, a user may need to click and hold on one location of an image and drag to a second location of the image and then release the mouse button to be properly authenticated. In other embodiments, a user may need to select multiple pre-designated locations in a media item in a certain order to be properly authenticated. In still other embodiments, a user may need to select multiple pre-designated locations in multiple pre-designated media items to be properly authenticated.

As has been discussed before, in some embodiments a user may be deemed authenticated when the user selects a location within a specific distance (whether the distance is spatial, temporal, or spatial-temporal) of the pre-designated location. That is to say, a user selection of a location in the selected media file that falls within the specific distance may be said to correspond to the pre-designated location. For example, with reference to the image 60, if the user selects the second button down 86 on the golfer's shirt as the pre-designated location, the user may be deemed authenticated during the authentication procedure if the user selects a location within a certain radius of the second button down 86, such as by number of pixels, physical distance in inches or centimeters or a fraction thereof, or by reference to features of the media itself. For example, the radius of acceptable user authentication for image 60 may be within half the distance between the second button down 86 and the nearest adjacent other button. Those of skill in the art will appreciate the varying spatial, temporal, and spatial-temporal margins of acceptable user authentication that may be used with embodiments of the present invention. For example, in situations of higher security, a smaller margin of error may be defined as acceptable, while in situations of lower security, a larger margin of error may be acceptable so as to prevent user dissatisfaction with rejected login attempts by authorized users.

In embodiments with spatial, temporal, or spatial-temporal location pre-designation, the user's selection of a pre-designated location may be tested before it is accepted. For example, when the user designates a media item as (one of) the pre-designated media items and further designates a location as the pre-designated location, the user may be presented with a screen similar to the interactive display 50 shown in FIG. 4. The user may then be asked to confirm the user's location designation by being prompted to select the correct location on the correct media item. If the user is able to do so successfully, the pictures may be rearranged or moved to different screen locations and/or started over (for temporal selections) and the user may be re-prompted to select the correct location on the correct media item. If the user is able to do so, the user's designation may be confirmed. If the user fails in either attempt to re-select the proper location, the user may be prompted to select a different media item/location. Alternatively, the user may be prompted with an option to expand the margin of acceptability in selecting the proper location and, if the option is selected, may be re-tested to ensure that the user may reliably choose the correct location.

In the embodiment illustrated in FIG. 4, the media-based authentication of the user may occur in a single step: the selection of the correct media item as well as the selection of the proper location in the media item may occur simultaneously. In some embodiments, these two steps may be performed separately, as illustrated with reference to FIGS. 3 and 5. In FIG. 3, the user may be prompted to select the correct image, as discussed above. After selection of an image, the user may then be presented with a display such as that illustrated in FIG. 5. The display of FIG. 5 may show the media item (in the illustrated case, the image 58) selected by the user, and may include a prompt 88 to select the correct location in the media item. If the user selects the proper location, the user may be deemed authenticated.

In the above-discussed examples, by choosing not just the correct media item but by also selecting the correct location in the correct media item, the likelihood is greatly increased that the person authenticated is an authorized user and is whom he or she represents him or herself as being. The above-described authentication models and steps are inexpensive to implement and represent a great increase in security in many situations. In some embodiments, security may be further enhanced by measuring how the user selects the correct image or selects the correct location on the correct image. For example, the time to selection and/or the number of incorrect choices before a correct choice may be measured. If too long a time period passes before a correct selection or if too many incorrect selections, such as two or three, occur before a correct selection, then additional challenge questions or authentication steps may be required before login is authorized.

In embodiments where the user must provide a correct location selection as well as a correct media item selection during authentication, the authentication procedure may function identically regardless of whether the correct picture is selected or not. For example, in the embodiments illustrated by FIG. 5, if an unauthorized user were to select the incorrect media item, the unauthorized user might still be presented with a prompt 88 to select the correct location in the media item. After selection of a location on the media item, the unauthorized user may be presented with a message such as, “Sorry, you have selected an incorrect image and/or an incorrect image location. Please try again.” Such a message would provide no indication to the unauthorized user whether the incorrect selection is of the media item or of the location within the media item. The unauthorized user would therefore have a difficult time in selecting the proper authentication image/location, especially if a lockout procedure is implemented after a given number of authentication attempts.

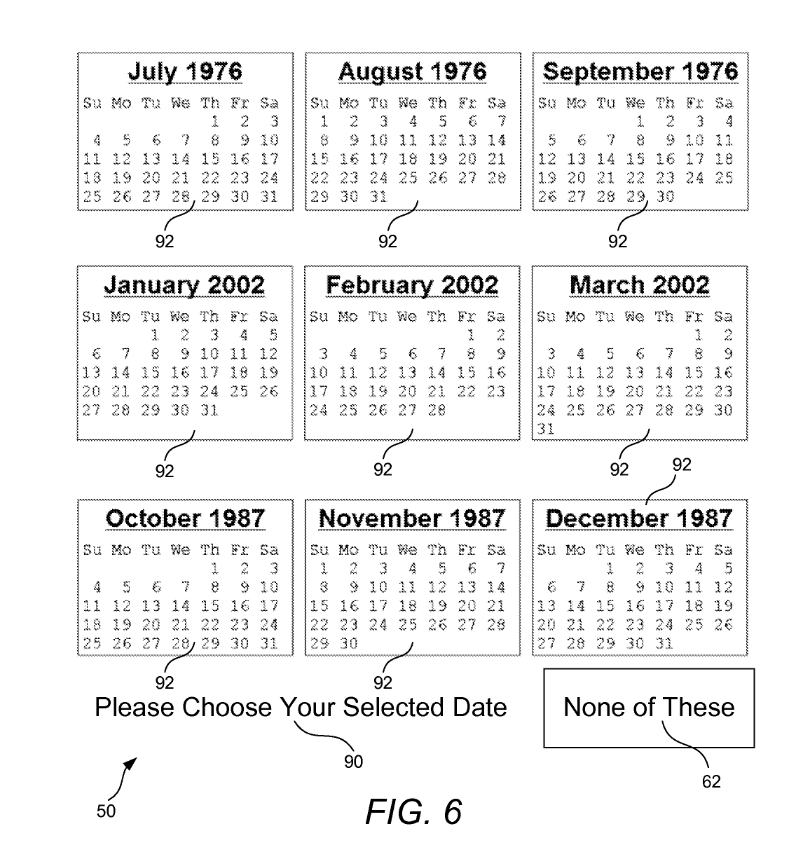

Modifications of the above-described authentication procedures may be implemented and still fall within the scope of embodiments of the invention. For example, FIG. 6 illustrates an alternative embodiment utilizing calendars. In the embodiment of FIG. 6, the interactive display 50 includes a prompt 90 to select the correct date and a number of monthly calendars 92. Although nine monthly calendars 92 are illustrated, any number of monthly calendars may be presented to the user. Each monthly calendar 92 may be viewed as a single media item, and each day within the monthly calendar corresponds to a particular location on that media item. Therefore, the use of monthly calendars 92 is analogous to the use of images as media items described above. In this way, the use of calendars may be provided in a way that is simple and easy to use, even for blind individuals or by telephone or auditory authentication. In some embodiments, the selection of a date by the user may be limited so that the user may not select his or her own birthday or anniversary or some other obviously significant date to reduce the likelihood of an unauthorized user guessing the chosen date. The provision of a “none” designator 62 serves the same purpose described above.

Other embodiments of the invention may make use of computer processing power and high-bandwidth network connections that are now available. These embodiments extend on the concept of selecting the proper location, and provide further likelihood of proper authentication. In these embodiments, selection of the proper location may occur through a zoom-in procedure, similar to or identical to those used in popular zoom-in computerized global location services, such as Google® Earth, MSN® Virtual Earth™, and other such services. In such embodiments, the user may begin with a global view of the entire earth, and may be asked to identify the user's chosen place. With the user's first selection, the user may zoom in to a single continent. With the user's second selection, the user may zoom in to a single country or state. With subsequent selections, the user may zoom in to a single region, city, postal area, etc. until the user has zoomed into a single precise location. Upon the final zoom step and selection, the user will either be authenticated, or an error message may be presented indicating that an incorrect location has been chosen. In this way, an unauthorized user may not know where in the zoom-in process the incorrect selection occurred. In this way, the media item may be an interactive media item, and the media item may be presented and user selections received using a media player, such as the ubiquitous Flash® player by Adobe Systems Incorporated of San Jose Calif., or any other media player.

Similar zooming/multi-layered authentication procedures may be used for other objects or devices. For example, a user's first selection might be among several automobiles. After selection of a particular automobile (whether correct or not), the user might choose to select an automobile component, such as drive train, cooling system, or engine. Further selection may zoom into a single part, such as a spark plug or even a portion thereof in the second cylinder on the right side. This zooming procedure may be done by schematic or even by text selection in some instances. Zooming of a selected calendar date may occur by century, month, date, and even time, if desired.

In other illustrative embodiments, a user seeking authentication may be required to select a pre-designated word from a pre-designated scripture, such as from the Bible, Torah, or Qur'an, or any other passage of text. The pre-designated word from the pre-designated passage may be displayed textually, in which case the location of the word in the text may correlate to the spatial or temporal location discussed above, or the pre-designated word may be temporally selected from an audio recording. This textual selection may also occur through a multi-step zoom-in procedure, such as by selection of a textual work, then a portion of that work, then a chapter, paragraph or verse, word, and even letter. For example, the user may pre-designate the “o” of “joy” in Isaiah 52:9 of the Old Testament of the King James version of the Bible, as the user's pre-designated authentication letter, and any other selection of a letter from millions of letters of thousands of verses from within the King James version of the Bible or from any other version of the Bible or from other textual works will not be correct. These textual embodiments may also make use of a “none” designator 62, as discussed previously. Those of skill in the art will appreciate the many variations of the above-described embodiments that may be made in accordance with the embodiments of the present invention. While embodiments have been described using selection of written text as a user authentication procedure, some embodiments may prevent the use of written textual passages as media items.

According to some embodiments of the present invention, the method of selecting a pre-designated media or portion thereof from an interactive display may be a second, third, fourth, etc., level of authentication. Accordingly, one or more authentication schemes can be implemented with the method of selecting a pre-designated media. For example, a username and password authentication scheme may precede one or more of the above-illustrated methods. In such embodiments, the interactive display 50 may include text boxes where a user types in a username and password, as is known to those of skill in the art. If the user fails to insert a proper username and corresponding password authentication can be denied and/or a user may be prompted to try again, as is known to those of skill in the art. After this initial authentication step, the user may then be presented with a media authentication step as discussed above. Other authentication levels, having other authentication schemes, may be included prior to or after the authentication methods described herein, as will be understood by those of skill in the art.

By way of example, in one embodiment, a hacker may have obtained a user's username and password, and may reach a first authentication step where the hacker is prompted to enter the ID and password. After doing so, the hacker may receive notification that the ID and password are correct followed by a notification such as: “As an added level of security and to confirm that you truly are ______, you will now be asked to select a picture retrieved from your profile.” The notification may be stated in this manner so as to cause the hacker to assume that the authorized user may actually have several pictures in his or her profile to draw on, even if such is not the case, making the hacker's choice even more challenging. Then, a media-based second authentication step may occur as discussed above. If desired, the media-based second authentication step may be followed by additional authentication steps.

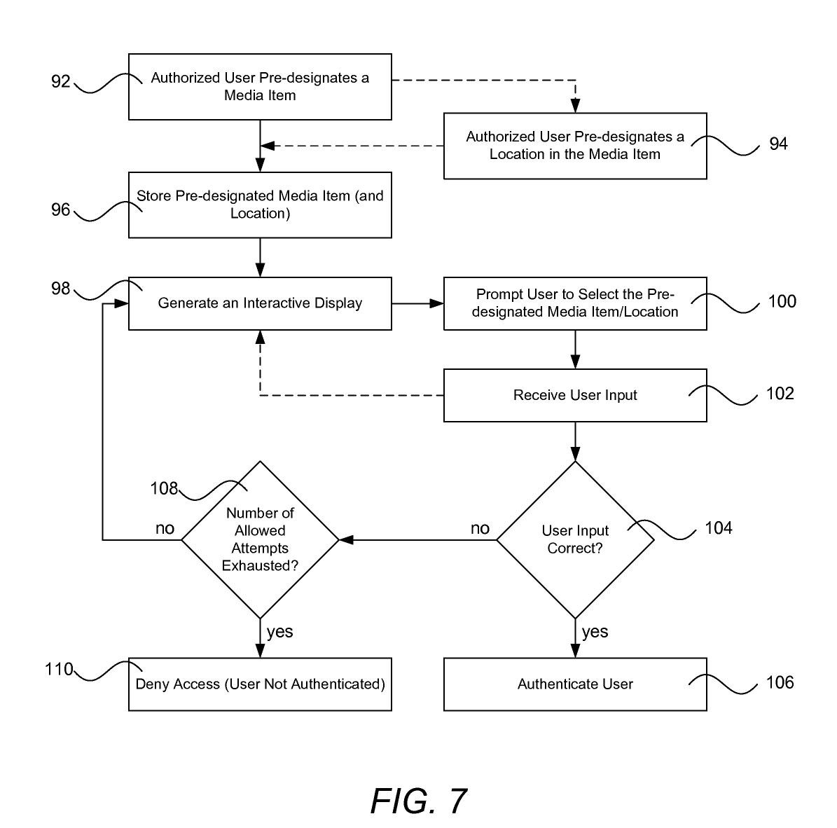

FIG. 7 illustrates methods for authenticating a user on a computer network according to embodiments of the invention and the above description. In some instances, the process may begin with step 92, where an authorized user, such as someone who is establishing a network or computer account or someone who has proved his or her identity to an acceptable level, is asked to pre-designate one or more media items for use in later authentication processes. After the user pre-designates the one or more media items at step 92, the authorized user may optionally be prompted to pre-designate a location in each selected media items at step 94. The pre-designation of a location in the selected media item(s) may be spatial, temporal, or both, as discussed above and based on the type of the media item(s). The first stage of the process ends with step 96, where the authorized user's selections are stored for later authentication procedures. As discussed above, in some embodiments, the authorized user may be tested to determine that the authorized user is reliably able to re-select the proper media item/location before the storage of the authorized user's selections occurs.

If the user chooses to access the system immediately, the process may continue to step 98, where an interactive display is generated. Alternatively, the process may begin at step 98 with the generation of an interactive display, such as when a user later desires to access the system. As discussed previously, the authentication steps illustrated in FIG. 7 beginning with step 98 and the generation of an interactive display may be preceded or followed by additional authentication steps in some embodiments, such as the entry of a username and/or password as well as the entry of other identifying information such as the answer to a challenge question. The interactive display generated at step 98 may include a plurality of media items, one of which may be one of the pre-designated media items selected at step 92.

If none of the media items displayed is one of the pre-designated media items, the generated interactive display may include a “none” designator 62, as discussed above. Alternatively, the authorized user may have previously been instructed that if none of the displayed media items is one of the pre-designated media items, the user should click in a blank area outside of the media items, on some other location such as prompt 52, or on a “submit” button but without a selection made in order to have additional media items displayed. If the subsequent user is not an authorized user and only incorrect media items are displayed, the subsequent user may not know to perform this additional action and will be unable to falsely authenticate.

As discussed above, the interactive display may include any type of media items, and may include prompts such as prompt 52 for the user to select a pre-designated image, prompt 64 to select the correct location on the correct media item, prompt 88 to select the correct location in the media item, prompt 90 to select the correct date, and optionally a “none” designator 62. The interactive display generated at step 98 may vary from login attempt to login attempt, and may vary within login attempts as the “none” designator 62 is selected or as a media item is selected and a user is prompted to then select a location from the selected media item. The arrangement and order of media items in the interactive display may be varied from login attempt to login attempt, and in some embodiments the eventual inclusion of the pre-designated media item(s) may be varied such as by replacing one pre-designated media item with another pre-designated media item, and even by including two pre-designated media items in the same interactive display.

After the interactive display is generated at step 98, the user is prompted to select the pre-designated media item and/or location at step 100. User input is then received at step 102. If the user input received at step 102 is the selection of a “none” designator 62, execution may then return to step 98 for an additional generation of an interactive display with new media items. Alternatively, if the user was prompted at step 100 merely to select the pre-designated media item and such a selection was made, execution may also return to step 98 for generation of an interactive display showing only the selected media item followed by a prompt at step 100 to select the pre-designated location, as illustrated in FIG. 5. Alternatively, in embodiments where a zoom-in type of procedure is used, steps 98-102 may be looped until a fully-zoomed-in selection is made of the user's chosen media location, as discussed above.

After user selection at the desired level is received, execution may proceed to decision block 104, where it is determined if the user input was correct. In some embodiments, whether user input is correct may be at least partially determined based on the amount of time passed before user input was received. As discussed above, the determination of whether the user input was correct may include determining whether the user input falls within a margin of acceptable error for a particular media location. If authentication is based solely on the selection of a proper media item, the determination of whether correct user input was received is based solely on the selection of a correct pre-designated media item. Where authentication is based on a correct location on a correct media item, the determination of whether correct user input was received may be based on both the selection of a correct media item as well as the selection of a correct location in the media item. If the user input is correct, execution proceeds to step 106, where the user is authenticated, at least through this level of the user authentication process. If the media-based authentication is the final authentication step, upon correct user input the user may be granted access to the network, application, site, or information to which access is being sought.

If the user input is incorrect, execution may proceed to decision block 108, where it is determined whether the user has exhausted the allowable number of login or authentication attempts. Even authorized users occasionally input incorrect authentication information occasionally, whether from an inadvertent mouse click for whatever reason, or from user forgetfulness of the proper media item/location. The use of media items as disclosed herein has been found advantageous in that user forgetfulness of media items is reduced when compared with the use of passwords, especially randomly-generated and harder-to-crack passwords, but even so, it is anticipated that occasionally an authorized user may input incorrect authentication data, and therefore a number of attempts may be allowed.

If the user has exhausted the allowable number of authentication attempts, execution proceeds to step 110, where access is denied. When access is denied, a computer having a particular MAC address or at a particular IP address may be permanently or temporarily blocked from further access attempts. Additionally, a message may be sent to an account holder, such as by e-mail, telephone call, or regular mail indicating that an apparently unauthorized attempt at authentication was made. If the user has not exhausted the allowable number of authentication attempts, execution may return to step 98 where an interactive display is generated again, either from the beginning or from some intermediate step, and the user may attempt to complete authorization as discussed above.

As may be appreciated from the above discussion, authentication based on media selection as set forth above is effective and inexpensive. The use of media may assist some users in remembering the pre-defined authentication media item (and location) in a way that is difficult if not impossible using textual passwords. Additionally, authentication based on media selection may assist in preventing phishing-type scams. It has been found that many users, when presented with a false website that only approximates an actual website, or when presented with a phishing-type e-mail, still enter their identifying information, making it available to criminals. However, such criminals would not be able or would not know such users' pre-designated media items, so in a phishing-type scam would be unable to present a valid selection to such users. The users are thus be alerted to the fact that the phishing-type scam is being attempted and would be able to take remedial action regarding their identifying information at a stage where the criminal elements had not yet obtained all information necessary to falsely authenticate themselves as the users.

The media-based authentication methods discussed herein are also cost-effective and inexpensive, requiring only a minor investment in infrastructure and storage. As may be appreciated by one of skill in the art, a large number of potential authentication media files may be stored using a minimal amount of network, hard drive, or other computer storage space. The authentication data for each user may be stored on an accessible but secure network location, and the storage space for each user's media authentication is minimal: merely a media item identifier and optionally a media location identifier for each pre-defined media item and location. The advent of high-bandwidth communications makes the use of such media files in authentication procedures for global network authentication feasible without incurring large delays in remote authentication procedures.

Thus, as discussed herein, embodiments of the present invention relate to electronic communications. In particular, systems and methods for authenticating the identity of electronic systems users, including network users, computer users, and the like are disclosed.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed and desired to be secured by Letters Patent is:

1. A method for providing user authentication comprising:
generating a first interactive display comprising a first plurality of media items, wherein one of the first plurality of media items is a first pre-designated media item;
prompting a user to select the first pre-designated media item from the first plurality of media items;
determining whether a selection of a selected media item by the user corresponds to the first pre-designated media item; and
providing user authentication when the user selects the first pre-designated media item.

2. The method of claim 1, wherein the first pre-designated media item is selected from a plurality of pre-designated media items, and wherein the step of generating a first interactive display comprises selecting the first pre-designated media item from the plurality of pre-designated media items for inclusion in the first interactive display.

3. The method of claim 1, further comprising;
requesting pre-designation of the first pre-designated media item from an authorized user; and
receiving pre-designation of the first pre-designated media item from the authorized user.

4. The method of claim 1, wherein the first pre-designated media item comprises a pre-designated location, the method further comprising:
prompting the user to select the pre-designated location; and
determining whether a selection of a media item location by the user corresponds to the pre-designated location;
wherein the step of providing user authentication is further conditional on the user selecting a location corresponding to the pre-designated location in the first pre-designated media item.

5. The method of claim 1, wherein the first pre-designated media item comprises a pre-designated location, the method further comprising:
prompting the user to select a location in the selected media item corresponding to the pre-designated location;
presenting a zoomed-in view of the selected media item at a location selected by the user;
repeating the steps of prompting the user to select a location and presenting a zoomed-in view until a maximum zoomed-in view of the selected media item is obtained;
prompting the user to select the pre-designated location in the maximum zoomed-in view; and
determining whether a selection of a selected media item location in the maximum zoomed-in view by the user corresponds to the pre-designated location;
wherein the step of providing user authentication is further conditional on the user selecting the pre-designated location in the first pre-designated media item.

6. The method of claim 1, further comprising:
generating a second interactive display comprising:
a second plurality of media items wherein none of the second plurality of media items is the first pre-designated media item; and
a designator capable of selection by the user to indicate that none of the second plurality of media items is the first pre-designated media item;
showing the second interactive display to the user before the first interactive display is shown to the user; and
showing the first interactive display to the user upon receiving a selection of the designator by the user.

7. The method of claim 1, wherein the first pre-designated media item and the first plurality of media items comprise media selected from the group of:
an image;
a color;
a pattern;
a video clip;
an audio clip;
an audio-visual clip;
a textual passage;
a calendar; and
a combination of two or more of an image, a video clip, an audio clip, an audio-visual clip, a textual passage, and a calendar.

8. A method for providing user authentication comprising:
presenting a view of a media item to an authenticating user wherein the media item comprises a pre-designated location that has been pre-designated by an authorized user;
prompting the authenticating user to select the pre-designated location as part of an authentication procedure;
receiving a selection of a location in the view of the media item from the authenticating user;
presenting a zoomed-in view of the media item corresponding to the selection of the location received from the authenticating user;
repeating the steps of receiving a selection of a location and presenting a zoomed-in view until a fully-zoomed-in view of the media item is presented to the authenticating user;
receiving a selection of a location in the fully-zoomed-in view of the media item from the authenticating user;
comparing the selection of the location in the fully-zoomed-in view of the media item with the pre-designated location; and
providing user authentication of the authenticating user when the selection of the location in the fully-zoomed-in view of the media item corresponds to the pre-designated location.

9. The method of claim 8, further comprising:
generating a first interactive display comprising a first plurality of media items, wherein the first plurality of media items comprises the media item having the pre-designated location; and
prompting the authenticating user to select the media item having the pre-designated location from among the first plurality of media items.

10. The method of claim 8, further comprising:
generating a first interactive display comprising a first plurality of media items and a designator indicating that none of the first plurality of media items is the media item having the pre-designated location;
generating a second interactive display comprising a second plurality of media items, wherein one of the first plurality of media items and the second plurality of media items comprises the media item having the pre-designated location;
displaying the first interactive display to the authenticating user; and
prompting the authenticating user to select the media item having the pre-designated location from among the first plurality of media items.

11. The method of claim 10, further comprising:
receiving a selection of the designator indicating that none of the first plurality of media items is the media item having the pre-designated location;
displaying the second interactive display to the authenticating user; and
prompting the authenticating user to select the media item having the pre-designated location from among the second plurality of media items.

12. The method of claim 8, further comprising:
presenting a view of the media item to the authorized user;
prompting the authorized user to pre-designate the pre-designated location;
receiving a selection of an authorized location in the view of the media item from the authorized user;
providing a zoomed-in view of the media item corresponding to the selection of the authorized location received from the authorized user;
repeating the steps of receiving a selection of an authorized location and providing a zoomed-in view of the media item corresponding to the selection of the authorized location until a fully-zoomed-in view of the media item is presented to the authorized user;
receiving a selection of a designated location in the fully-zoomed-in view from the authorized user; and
storing the designated location as the pre-designated location.

13. A computer program product stored on a computer readable medium for implementing within a computer system a method for authenticating a user, the computer program product comprising:
computer program code means utilized to implement the method, wherein the computer program code means is comprised of executable code for implementing the steps of:
generating a first interactive display comprising a first plurality of media items and a designator indicating that none of the first plurality of media items is a correct media item;
generating a second interactive display comprising a second plurality of media items, wherein a media item selected from the first plurality of media items and the second plurality of media items is the correct media item;
displaying the first interactive display to a user;
prompting the user to select the correct media item; and
providing authentication of the user when the user selects the correct media item.

14. The computer program product of claim 13 wherein the computer program code means further comprises executable code for implementing the steps of:
receiving a selection of the designator indicating that none of the first plurality of media items is the correct media item; and
displaying the second interactive display to the user.

15. The computer program product of claim 13 wherein the computer program code means further comprises executable code for implementing the steps of:
storing a pre-designated location of the correct media item;
prompting the user to select the pre-designated location; and
determining whether a selection of a media item location by the user corresponds to the pre-designated location;
wherein the step of providing authentication of the user is further conditional on the selection of the media item location corresponding to the pre-designated location in the correct media item.

16. The computer program product of claim 15 wherein the pre-designated location is one of:
a spatial location in the correct media item;
a temporal location in the correct media item; and
a spatial-temporal location in the correct media item.

17. A computer program product stored on a computer readable medium for implementing within a computer system a method for authenticating a user, the computer program product comprising:
computer program code means utilized to implement the method, wherein the computer program code means is comprised of executable code for implementing the steps of:
generating a first interactive display comprising a first plurality of media items and a designator indicating that none of the first plurality of media items is a correct media item;
generating a second interactive display comprising a second plurality of media items, wherein a media item selected from the first plurality of media items and the second plurality of media items is a correct media item having a pre-designated location;
displaying the first interactive display to a user;
prompting the user to select the pre-designated location in the correct media item; and
providing authentication of the user when the user selects a location in a media item corresponding to the pre-designated location in the correct media item.

18. The computer program product of claim 17 wherein the computer program code means further comprises executable code for implementing the steps of:
prompting the user to select the correct media item; and
receiving a selection of a media item from the user.

19. The computer program product of claim 17 wherein the computer program code means further comprises executable code for implementing the steps of:
receiving a selection of the designator indicating that none of the first plurality of media items is the correct media item having the pre-designated location; and
displaying the second interactive display to the user.

20. The computer program product of claim 17 wherein the computer program code means further comprises executable code for implementing the steps of:
prompting the user to select a location in a selected media item corresponding to the pre-designated location;
presenting a zoomed-in view of the selected media item at a location selected by the user;
repeating the steps of prompting the user to select a location and presenting a zoomed-in view until a maximum zoomed-in view of the selected media item is obtained;
prompting the user to select the pre-designated location in the maximum zoomed-in view; and
determining whether a selection of a media item location in the maximum zoomed-in view by the user corresponds to the pre-designated location;
wherein the step of providing authentication of the user is further conditional on the media item location corresponding to the pre-designated location in the correct media item.
